(19) United States
(12) Patent Application Publication
(10) Pub. No.: US 2025/0236690 A1
(43) Pub. Date: Jul. 24, 2025

(54) CONFORMANCE IMPROVEMENT IN HYDROCARBON-BEARING RESERVOIR USING GREEN CROSSLINKERS

(71) Applicant: The Curators of the University of Missouri, Columbia, MO (US)

(72) Inventors: Tao Song, Rolla, MO (US); Baojun Bai, Rolla, MO (US); Thomas P. Schuman, Rolla, MO (US); Mohamed Ahdaya, Midland, TX (US)

(73) Assignee: The Curators of the University of Missouri, Columbia, MO (US)

(21) Appl. No.: 18/855,511

(22) PCT Filed: Apr. 21, 2023
(86) PCT No.: PCT/US2023/066082

§ 371 Date: Oct. 9, 2024

Related U.S. Application Data
(60) Provisional application No. 63/333,300, filed on Apr. 21, 2022.

(51) Int. Cl. C08F 22/38; C08F 26/10; C08J 3/24

(52) U.S. Cl. CPC C08F 22/38; C08F 26/10; C08J 3/24

(57) ABSTRACT

The present disclosure is broadly concerned with green crosslinkers for use with reservoir temperatures ranging from about 80° C. to about 130° C. These green crosslinkers can crosslink acrylamide-based polymers with crosslinking times ranging from several hours to weeks. The mixture of this green crosslinker with an acrylamide-based polymer solution can be applied to plug reservoirs with fractures and/or matrix channels. Moreover, it can be used in different permeability reservoirs with various channeling problems.

### CROSS-REFERENCE TO RELATED APPLICATIONS

The present application claims the priority benefit of U.S. Provisional Patent Application Ser. No. 63/333,300, filed Apr. 21, 2022, entitled CONFORMANCE IMPROVEMENT IN HYDROCARBON-BEARING RESERVOIR USING GREEN CROSSLINKERS, the entirety of which is incorporated by reference herein.

### BACKGROUND

### Field

The present disclosure generally relates to the field of oilfield chemistry. More particularly, the disclosure is related to a high temperature (e.g., about 80 to about 130° C.) resistant polymer gel system that can be crosslinked in petroleum reservoirs, and the preparation and use thereof.

### Description of Related Art

Polymer gels have been applied to address excessive water or gas production from hydrocarbon-bearing reservoirs. One of the most commonly used gel systems is an in-situ polymer gel system. This gel system forms a flowing or rubber-like bulk gel after being placed in a formation. The gel physically plugs the high conductivity features, diverting the post-injected fluids to less permeable, unswept oil zones.

The in-situ polymer gel systems are mainly composed of two components: polymers and crosslinkers. The polymers are typically synthetic polymers such as acrylamide-based polymers and natural polymers such as xanthan and tannic acid. Typical crosslinkers include inorganic crosslinkers such as Al (III), Cr (III), and Zr (IV), and organic crosslinkers such as phenol/formaldehyde, polyethyleneimine (PEI), and chitosan. However, most countries have phased out metal crosslinkers and phenol/formaldehyde-based organic crosslinkers due to their high toxicity and carcinogenic nature. PEI, a less toxic crosslinker, has been applied in the field extensively and has a high success rate. However, PEI is highly toxic to aquatic creatures and has been phased out from the Norwegian section of the North Sea. Therefore, the less toxic chitosan has been used in place of PEI. However, chitosan has limited solubility in water. Furthermore, the solubility decreases with increasing pH, and precipitation can be observed when the solution pH is higher than 6.0, making chitosan-based in-situ polymer gels susceptible to pH. After being diluted by the alkaline formation water, precipitation and phase separation cannot be avoided, even when pretreated with acetic or hydrochloric acid.

### SUMMARY

In one embodiment, the disclosure provides a polymer crosslinked with an amino acid compound. The polymer comprises recurring units comprising an amido group, and the amino acid compound is chosen from amino acids, poly(amino acids), amino acid salts, and/or poly(amino acid) salts.

In another embodiment, the disclosure provides a gel comprising a polymer crosslinked with an amino acid compound. The polymer comprises recurring units comprising an amido group, and the amino acid compound is chosen from amino acids, poly(amino acids), amino acid salts, and/or poly(amino acid) salts.

In a further embodiment, a method of altering or controlling the flow of a fluid in an environment is provided. The method comprises introducing a polymer and an amino acid compound into the environment. The polymer comprises recurring units comprising an amido group, and the amino acid compound is chosen from amino acids, poly(amino acids), amino acid salts, and/or poly(amino acid) salts.

### BRIEF DESCRIPTION OF THE DRAWING FIGURES

FIG. 1 is a schematic illustrating the gel strength descriptions used herein;

FIG. 2 is a photograph showing the crosslinking behavior of 7% AB-055+1% Lysine monohydrochloride (Example 2);

FIG. 3 is a photograph of the crosslinked gel of Example 2;

FIG. 4 is a scanning electron microscope photograph showing the microstructure of the crosslinked gel of Example 2;

FIG. 5 is a schematic showing the sandstone parameters and equipment setup for the core flooding testing described in Example 4;

FIG. 6 is a graph of the stepwise breakthrough testing results described in Example 5; and

FIG. 7 is a graph of the Fᵣᵣ test results obtained as described in Example 5.

### DETAILED DESCRIPTION

The present disclosure is broadly concerned with gelants, polymer gel systems formed from the gelants, and methods of using the foregoing to control and/or alter fluid flow in environments such as petroleum reservoirs.

### Gelants

Gelants as described herein comprise a polymer and an amino acid compound.

### 1. Polymers

Suitable polymers for use in the gelants preferably comprise recurring monomeric units comprising respective amido groups. Examples of suitable monomers include amides, such as those chosen from acrylamide, methacrylamide, or combinations of the foregoing.

While the polymer can be a homo-polyacrylamide, it is preferably a copolymer with at about least 20 mol %, more preferably at least about 30 mol %, and even more preferably about 35 mol % to about 100 mol % of unsubstituted acrylamide-based monomers. In one embodiment, the polymer further comprises one or more comonomers chosen from acrylic acid, 2-acrylamido-2-methyl propane sulfonic acid monomers, N-vinyl-2-pyrrolidone monomers, 4-vinylpyridine monomers, 1-vinylimidazole monomers, sodium 4-vinylbenzenesulfonate monomers, or combinations thereof, with acrylic acid being a particular preferred comonomer.

In another embodiment, the polymer is a copolymer of an amide (such as those described above) and acrylic acid. The copolymer can include only those two monomers, or it can also include one or more of 2-acrylamido-2-methyl propane sulfonic acid monomers, N-vinyl-2-pyrrolidone monomers, 4-vinylpyridine monomers, 1-vinylimidazole monomers, sodium 4-vinylbenzenesulfonate monomers, or combinations thereof.

In one embodiment, the polymer comprises recurring units of

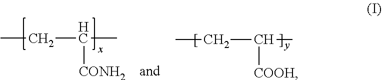

where:
x is about 0% to about 100% by mols, preferably about 20% to about 100% by mols, more preferably about 60% to about 100% by mols, even more preferably about 60% to about 99% by mols, and most preferably about 80% to about 95% by mols; and/or
y is about 0% to about 100% by mols, preferably about 0% to about 40% by mols, more preferably about 1% to about 40% by mols, and even more preferably about 5% to about 20% by mols.
“% by mols” as used herein is based on the total mols in the polymer taken as 100%. Additionally, each of the above and below mol % ranges can be “mixed and matched” with one another.

In another embodiment, the polymer comprises recurring units of

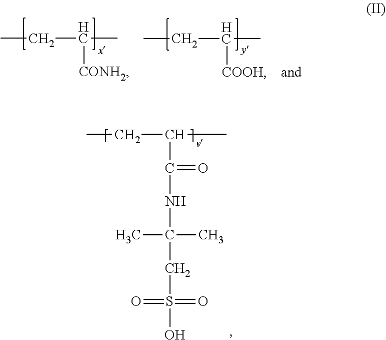

where:
x′ is about 5% to about 80% by mols, preferably about 10% to about 40% by mols, and more preferably about 10% to about 20% by mols;
y′ is about 0% to about 20% by mols, preferably about 0% to about 10% by mols, and more preferably about 0% to about 5% by mols of y′, or in some embodiments about 1% to about 20% by mols, preferably about 1% to about 10% by mols, and more preferably about 1% to about 5% by mols; and/or
v′ is about 0% to about 80% by mols, preferably about 1% to about 80% by mols, more preferably about 20% to about 80% by mols, and even more preferably about 50% to about 80% by mols.

In yet a further embodiment, the polymer comprises recurring units of

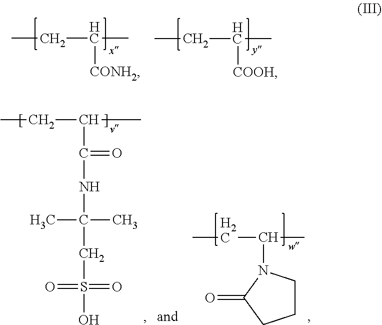

where:
x″ is about 0% to about 60% by mols, preferably about 1% to about 60% by mols, more preferably about 10% to about 50% by mols, and even more preferably about 20% to about 30% by mols;
y″ is about 0% to about 20% by mols, preferably about 0% to about 10% by mols, and more preferably about 0% to about 5% by mols of y″, or in some embodiments about 1% to about 20% by mols, preferably about 1% to about 10% by mols, and more preferably about 1% to about 5% by mols;
v″ is about 0% to about 50% by mols, preferably about 1% to about 50% by mols, more preferably about 10% to about 40% by mols, and even more preferably about 20% to about 40% by mols; and/or
w″ is about 0% to about 60% by mols, preferably about 1% to about 60% by mols, more preferably about 20% to about 60% by mols, and even more preferably about 40% to about 60% by mols.

In some embodiments, the gelant solution comprises a single polymer type. In other embodiments, the gelant solution can comprise two or more polymer types, including two or three of (I), (II), or (III) above.

Regardless of the polymer included in the gelant solution, it is preferred that the polymer has an weight average molecular weight in million Daltons of about 0.05 to about 30, preferably about 0.1 to about 25, more preferably about 0.2 to about 8, and even more preferably about 0.5 to about 8, as determined by GPC.

In some embodiments, the polymer has a mol % hydrolysis of about 1% to about 40%, preferably about 1% to about 35%, more preferably about 1% to about 15%, and even more preferably about 1% to about 10%. The degree of hydrolysis can be determined by titration, Infrared spectroscopy, and Nuclear Magnetic Resonance Spectroscopy.

Table 1 provides a non-exclusive list of some commercially available polymers that can be used in the disclosed gelants.

TABLE 1

| | | Molecular |
|---|---|---|
| | | weight/ |
| Product* | Composition | 10⁶ g · mol |
| FLODRILL ™ | Acrylamide + Acrylic acid | <0.5 |
| AB 055 | | |
| AN-907 | Acrylamide + Acrylic acid | 8~10 |
| AN-125 VLM | Acrylamide | 2~3 |
| | 2-Acrylamido-2-methyl propane | |
| | sulfonic acid | |
| SAV-225 | Acrylamide | 2~4 |
| | 2-Acrylamido-2-methyl propane | |
| | sulfonic acid | |
| | N-Vinyl-2-pyrrolidone | |

*Polymers obtained from SNF Group

Other commercially available polyacrylamides suitable for use herein include SNF Group's FLODRILL™ AN-905 and FLOPAAM 3230, 3330, 3430, and 3630S, all of which are partially hydrolyzed polyacrylamides (acrylamide-co-acrylic acid) with structures similar to the structure of AB-055 and AN-907 but with different molecular weights and degrees of hydrolysis.

### 2. Amino Acid Compound

Suitable amino acid compounds include those chosen from amino acids, poly(amino acids), amino acid salts, and/or poly(amino acid) salts. Preferably, the amino acid compound does not include any aromatic groups.

The amino acid compound has an LC50 and/or an EC50 of about 50 mg/L or higher, more preferably about 75 mg/L or higher, and even more preferably about 100 mg/L or higher, making it an environmentally friendly selection. As used herein, LC50 is determined by OECD Test (Guideline 403). EC 50 is determined by OECD Test (Guideline 202).

Examples of suitable amino acid compounds include lysine (preferably L-lysine), polylysine (preferably poly-L-lysine), lysine-monohydrochloride (preferably L-lysine-monohydrochloride), polyarginine, polyhistidine, or combinations thereof.

It is preferred that the polymer and amino acid compound are dissolved or dispersed in a solvent to form a solution or dispersion. Any solvent that can act as a carrier fluid for the polymer and amino acid compound is suitable, including fresh water, produced water, sea water, brine, drilling fluid, servicing fluid water, or mixtures of the foregoing. In these embodiments, the solvent is typically included at levels of about 90% by weight to about 99.5% by weight, preferably about 91% by weight to about 99% by weight, and more preferably about 93% by weight to about 99% by weight, based upon the total weight of the gelant solution taken as 100% by weight.

It is preferred that the weight ratio of polymer to amino acid compound is about 100:1 to about 1:1, preferably about 50:1 to about 3:1, and more preferably about 30:1 to about 3:1.

When the gelant is a gelant solution, the polymer will be included at levels of about 0.5% by weight to about 9.5% by weight, preferably about 1% by weight to about 9% by weight, and more preferably about 1% by weight to about 7% by weight, based upon the total weight of the gelant solution taken as 100% by weight. The amino acid compound will be included at levels of about 0.005% by weight to about 3.17% by weight, preferably about 0.02% by weight to about 3% by weight, and more preferably about 0.03% by weight to about 2.3% by weight, based upon the total weight of the gelant solution taken as 100% by weight.

In some embodiments, the gelant consists essentially of, or even consists of, the polymer(s), amino acid compound(s), and solvent(s). In some embodiments, the gelant solution consists essentially of, or even consists of, the polymer(s), amino acid compound(s), and one or more additives (e.g., fiber, nano-silica, clay (e.g., bentonite and laponite), mica, and/or walnut shells.

### Methods of Use and Formed Gels

In use, the gelant or gelant solution is introduced into an environment where it is desirable to alter or control the flow of fluid. This environment is typically a subterranean environment, such as wells and pipelines. For example, the gelant or gelant solution can be used to improve the conformance of water flooding, for controlling water production, increasing petroleum recovery, and/or as a diverter for well stimulation. The gel or gelant solution can form a gel in, for example, fractures, conduits, lost-circulation zones, cavernous formations, high-permeability zones, wellbores, and/or perforations.

The gelant or gelant solution can be introduced into the particular environment by a few different methods. For example, in some embodiments, the polymer and amino acid compound could be separately introduced into the environment, preferably with one or both being in a carrier fluid as described previously.

In other embodiments, the polymer and amino acid compound are combined or mixed prior to introduction into the target environment, so that the formed gelant or gelant solution is introduced. This mixing of the polymer and amino acid compound could be carried out some amount of time prior to introduction into the target environment, with or without a carrier fluid. The combining of the two could also or instead take place at the time of introduction, with a carrier fluid or solvent, as described above. In a particularly preferred embodiment, the polymer and amino acid compound are mixed in a carrier fluid prior to introduction into the environment to be treated.

Advantageously, the polymer and amino acid compound (with or without a carrier fluid/solvent) do not react upon mixing at temperatures of about 65° C. or lower. Thus, the gelant or gelant solution can be formed and stored at a temperatures of about 65° C. or lower for 30 days or longer, 6 months or longer, or even 12 months or longer.

The polymer and amino acid compound will begin to crosslink once they reach the locations in the environment where the temperature is at or above the crosslinking temperatures of the particular polymer and amino acid compound. This is preferably accomplished by one or more amido groups on the polymer reacting with respective amino groups on the amino acid compound.

Scheme A provides a representation of this crosslinking mechanism:

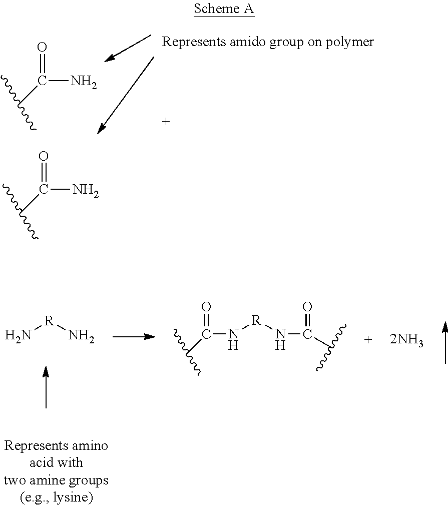

R in the above schematic represents the remaining portion of the particular amino acid utilized, and the squiggly lines represent the remainder of the polymer. While the above schematic represents an amino acid with two amino groups, any amino acid (including salts and polymers thereof) is considered within the scope of this disclosure.

In some embodiments, the polymer and amino acid compound crosslink at temperatures of about 90° C. to about 110° C., preferably about 95° C. to about 105° C., and more preferably about 99° C. to about 101° C. Preferably, this crosslinking takes place within about 6 days to about 16 days, more preferably within about 7 days to about 14 days, and even more preferably within about 7 days to about 9 days.

In other embodiments, the polymer and amino acid compound crosslink at temperatures of about 110° C. to about 130° C., preferably about 115° C. to about 125° C., and more preferably about 119° C. to about 121° C. Preferably, this crosslinking takes place within about 15 hours to about 48 hours, more preferably within about 15 hours to about 40 hours, and even more preferably within about 20 hours to about 36 hours.

In yet further embodiments, the polymer and amino acid compound crosslink at temperatures of about 120° C. to about 140° C., preferably about 125° C. to about 135° C., and more preferably about 129° C. to about 131° C. Preferably, this crosslinking takes place within about 8 hours to about 36 hours, more preferably within about 10 hours to about 32 hours, and even more preferably within about 12 hours to about 28 hours.

Advantageously gelation can take place over a broad pH range of about 2 to about 10. The gelation time can also be decreased by decreasing the pH.

Regardless of the times and temperatures, the formed gels are environmentally friendly and possess a number of advantageous properties, making them useful for, among other uses, improving the conformance of reservoirs with stringent environmental regulations. For example, the formed gel preferably has an LC50 and/or an EC50 of about 50 mg/L or higher, more preferably about 75 mg/L or higher, and even more preferably about 100 mg/L or higher.

In some embodiments, gels formed as described herein have an elastic modulus of about 50 Pa to about 400 Pa, preferably about 60 Pa to about 360 Pa, and more preferably about 75 Pa to about 330 Pa.

In other embodiments, gels according to this disclosure have an elastic modulus of about 10 Pa to about 90 Pa, preferably about 15 Pa to about 80 Pa, and more preferably about 20 Pa to about 60 Pa. In still further embodiments, these gels have an elastic of about 5 Pa to about 50 Pa, preferably about 8 Pa to about 35 Pa, and more preferably about 10 Pa to about 20 Pa. In some embodiments, an elastic modulus of about 500 Pa can be achieved. As used herein, elastic modulus of a gel is determined as described in Example 1.

The gels formed as described herein preferably have a Residual Resistance Factor (Frr) of about 50,000 or greater, preferably about 55,000 or greater, and more preferably about 60,000 or greater at an injection rate of about 0.1 cc/mL. Frr is determined as defined in Example 5.

In some embodiments, the gels have a plugging efficiency of about 90% or greater, preferably about 95% or greater, more preferably about 98% or greater, and even more preferably about 99% or greater. Preferably this plugging efficiency is present at about 130° C., among other temperatures. Plugging efficiency is determined as defined in Example 5.

Additionally, the gels are preferably thermally stable at a temperature of about 130° C. for about 120 days or greater. “Thermally stable” as used herein means that less than about 10%, preferably less than about 5%, more preferably less than about 2%, and even more preferably about 0% gel volume loss takes place after this time period and at this temperature.

The gels also exhibit high breakthrough pressures when subjected to a core flooding test using a 5 Darcy sandstone as described in Example 5. That is, breakthrough pressures of about 800 psi/feet or higher, preferably about 1,000 psi/feet or higher, and more preferably about 1,300 psi/feet or higher are achieved.

Additional advantages of the various embodiments will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the disclosure. It is to be understood, however, that these examples are provided by way of illustration, and nothing therein should be taken as a limitation upon the overall scope.

### Example 1

### Methods

Polymer solutions were prepared by slowly adding the polymer powder into the freshwater and stirring at 65° C. for 6 hours to get a homogenous polymer solution. The polymer solution was then allowed to cool to ambient temperature. Subsequently, L-Lysine-monohydrochloride (Lys-Cl) or L-Lysine (Lys) powder was added to the polymer solution followed by stirring at ambient conditions for 1 hour to obtain a homogenous gelant solution.

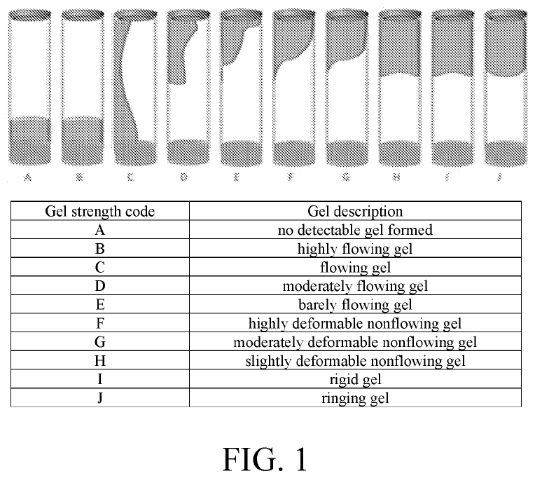

The bottle tests method (Sydansk, R. D. “A New Conformance-Improvement-Treatment Chromium (III) Gel Technology.” Paper presented at the SPE Enhanced Oil Recovery Symposium, Tulsa, Oklahoma, April 1988, incorporated by reference herein) was adopted to determine the crosslinking time. High-temperature and pressure-resistant glass tubes were employed to characterize the crosslinking behavior of the gelant. The gelant samples were sparged with ultra-high purity argon for 20 minutes before sealing. The crosslinking start time was defined as the time when the polymer solution changed to a moderately flowing gel (gel Code D of FIG. 1) (See, Zhu, D., Hou, J., and Bai, B. 2019. Evaluation of terpolymer-gel systems crosslinked by polyethylenimine for conformance improvement in high-temperature reservoirs. SPE Journal 24 (04): 1,726-1,740, incorporated by reference herein).

After fully crosslinking, the gel strength was evaluated via a HAAKE MARS III Rheometer using a parallel plate geometry (PP35L Ti L) with a gap of 1 mm. All the rheology tests were carried out in the linear viscoelastic region at ambient temperature. In addition, the elastic modulus and viscous modulus of the gels were tested through a time-dependent oscillation experiment at a fixed frequency of 1 Hz and a controlled strain of 1%.

### Example 2

### AB-055 Polymer Gel System

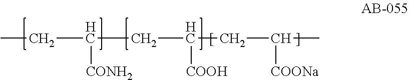

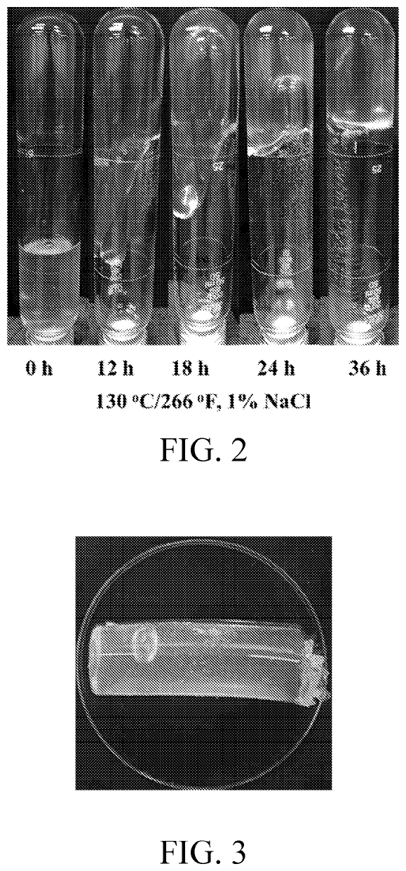

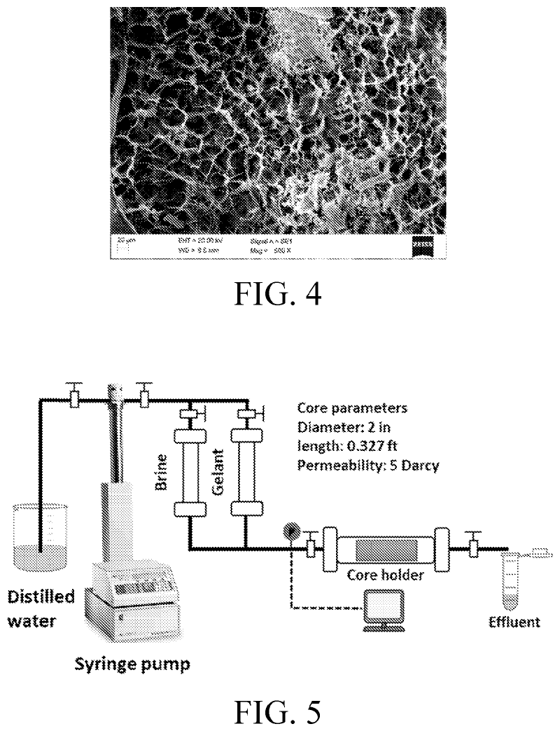

A stock solution of 7 wt % AB-055 was prepared in freshwater. Next, 0.3 g of Lys-Cl was added to 30 mL of AB-055 solution, and the pH of the gelant solution was 6.1. The resulting solution was aged at different temperatures to evaluate the crosslinking behavior. Testing parameters, crosslinking time, and the elastic modulus of the fully crosslinked gel are shown in Table 2. FIG. 2 shows the crosslinking behavior of the 7 wt % AB-055 and 1 wt % of Lys-Cl gel at 130° C., FIG. 3 is a photograph of the crosslinked gel, and FIG. 4 shows the gel's microstructure.

TABLE 2
Crosslinking start time under different temperatures

| | Crosslinking | | Elastic modulus after fully |
|---|---|---|---|
| Temperature, ° C./° F. | time | | crosslinking/Pa |
| 80/176 | 24~28 | days | 80.6 |
| 90/194 | 18~20 | days | 142.3 |
| 100/212 | 7~9 | days | 244.8 |
| 120/248 | 20~24 | hours | 310.2 |
| 130/266 | 12~16 | hours | 320.9 |

### Example 3

### AN-125 VLM Polymer Gel System

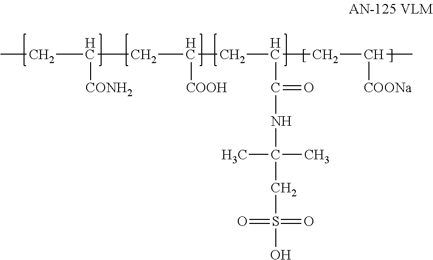

A stock solution of 3 wt % AN-125 VLM was prepared in freshwater. Next, 0.3 g of Lys-Cl was added to 30 mL of AN-125 VLM solution. The pH of the gelant solution was 5.8. The resulting solution was aged at different temperatures to evaluate the crosslinking behavior. Testing parameters, crosslinking time, and elastic modulus of the fully crosslinked gel are shown in Table 3.

TABLE 3
Crosslinking Start Time Under Different Temperatures

| | Crosslinking | | Elastic modulus after fully |
|---|---|---|---|
| Temperature, ° C./° F. | time | | crosslinking/Pa |
| 100/212 | 7~9 | days | 22.6 |
| 120/248 | 24~28 | hours | 45.1 |
| 130/266 | 20~24 | hours | 56.4 |

### Example 4

### SAV-225 Polymer Gel System

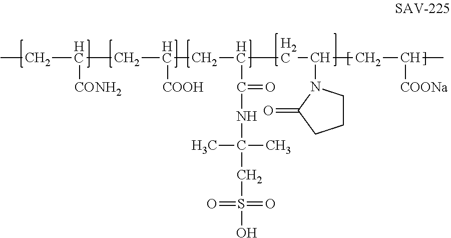

A stock solution of 3 wt % SAV-225 was prepared in freshwater. 0.3 g of Lys-Cl was added to 30 mL of SAV-225 solution, and the pH of the gelant solution was 6.0. The resulting solution was aged at different temperatures to evaluate the crosslinking behavior. Testing parameters, crosslinking time, and elastic modulus of the fully crosslinked gel are shown in Table 4.

TABLE 4
Crosslinking Start Time Under Different Temperatures

| | Crosslinking | | Elastic modulus after fully |
|---|---|---|---|
| Temperature, ° C./° F. | time | | crosslinking/Pa |
| 100/212 | 12~14 | days | 12.0 |
| 120/248 | 30~36 | hours | 16.2 |
| 130/266 | 24~28 | hours | 19.9 |

### Example 5

### Core Flooding Experiments

The plugging efficiency of the polymer gels was evaluated using a high permeability sandstone. The experimental setup and core parameters are shown in FIG. 5. First, the gelant (7% AB-055 and 1% Lysine monohydrochloride in freshwater) was injected into the core with a constant injection rate of 0.5 mL/min until the injection pressure became stable. After that, the core was sealed and aged at 130° C. for 5 days, after which the step-wise breakthrough test was performed to obtain the breakthrough pressure. After the water breakthrough, the injection rate was changed to 0.1, 0.25, 0.5, and 1 mL/min, and the stable pressure was recorded to calculate the Residual Resistance Factor (Fᵣᵣ). Fᵣᵣ is used to calculate plugging efficiency and is the ratio of water or oil phase mobility before and after the plugging agent is injected (i.e., permeability before gel treatment/permeability after gel treatment). Plugging efficiency=(1−1/Fᵣᵣ)*100%.

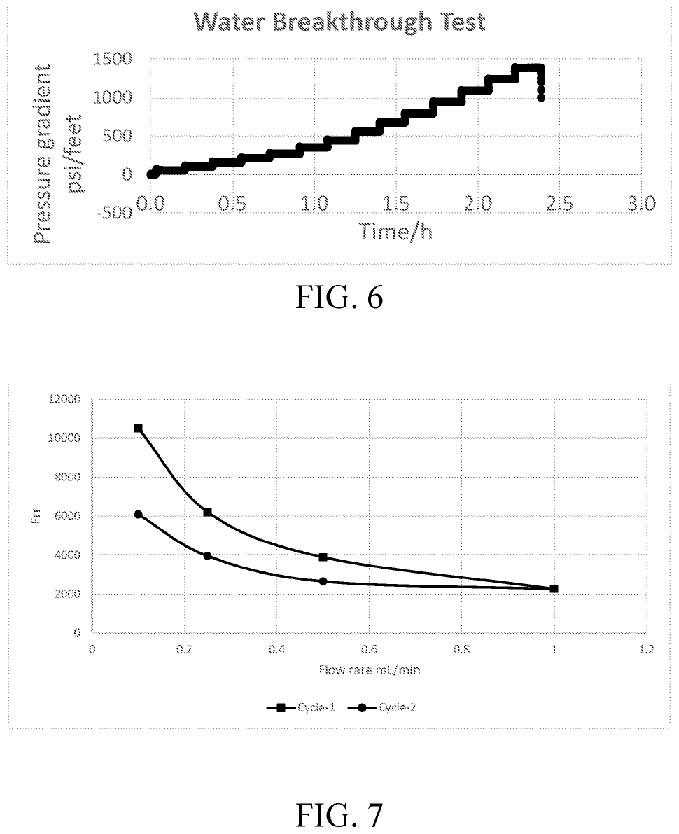

The crosslinked gel had an excellent plugging performance. The breakthrough pressure was 1,440 psi/feet, as shown in FIG. 6. The Fᵣᵣ was around 6,000 at an injection rate of 0.1 cc/mL, and the plugging efficiency was higher than 99.9% (see FIG. 7).

1. A polymer crosslinked with an amino acid compound, said polymer comprising recurring units comprising an amido group, and said amino acid compound being chosen from amino acids, poly(amino acids), amino acid salts, and/or poly(amino acid) salts.

2. The polymer of claim 1, wherein at least some of said amido groups are crosslinked with said amino acid compound.

3. The polymer of claim 1, wherein said polymer comprises an acrylamide/acrylic acid copolymer.

4. The polymer of claim 1, wherein said polymer further comprises comonomers chosen from 2-acrylamido-2-methyl propane sulfonic acid monomers, N-vinyl-2-pyrrolidone monomers, 4-vinylpyridine monomers, 1-vinylimidazole monomers, sodium 4-vinylbenzenesulfonate monomers, or combinations thereof.

5. The polymer of claim 1, wherein said polymer comprises:
(I) recurring units of 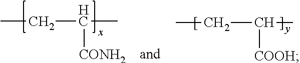
(II) recurring units of 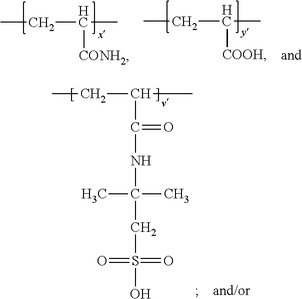
(III) recurring units of

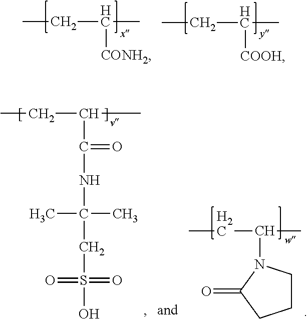

6. The polymer of claim 1, wherein said amino acid compound is chosen from lysine, polylysine, lysine-monohydrochloride, polyarginine, polyhistidine, or combinations thereof.

7. The polymer of claim 1, wherein the weight ratio of polymer to amino acid compound is about 100:1 to about 1:1.

8-9. (canceled)

10. A gel comprising the polymer of claim 1.

11. The gel of claim 10, wherein said gel comprises an elastic modulus of about 5 Pa to about 400 Pa.

12-13. (canceled)

14. A method of altering or controlling the flow of a fluid in an environment, the method comprising introducing a polymer and an amino acid compound into the environment, wherein:
said polymer comprises recurring units comprising an amido group; and
said amino acid compound is chosen from amino acids, poly(amino acids), amino acid salts, and/or poly(amino acid) salts.

15. (canceled)

16. The method of claim 14, wherein:
said polymer and said amino acid compound are separately introduced into said environment; or
said polymer and said amino acid compound are stored in a solution together prior to introduction into said environment, preferably at a temperature of about 65° C. or lower.

17. The method of claim 14, wherein said polymer and said amino acid compound form a gel having:
an Frr of about 50,000 or greater at an injection rate of about 0.1 cc/mL; and/or
a plugging efficiency of about 90% or greater.

18. The method of claim 14, wherein said polymer and said amino acid compound contact one another and begin to crosslink after said introducing.

19. The method of claim 18, wherein said polymer is crosslinked with said amino acid compound within about 6 days to about 16 days.

20. The method of claim 19, wherein said crosslinking takes place at temperatures of about 90° C. to about 110° C.

21-24. (canceled)

25. The method of claim 18, wherein said polymer and amino acid compound crosslink to form a gel comprising an elastic modulus of about 5 Pa to about 400 Pa.

26-27. (canceled)

28. The method of claim 18, wherein said crosslinking comprises at least some of said amido groups crosslinking with said amino acid compound, preferably through an amino group on the amino acid compound.

29. The method of claim 14, wherein said polymer comprises an acrylamide/acrylic acid copolymer.

30. The method of claim 14, wherein said polymer further comprises comonomers chosen from 2-acrylamido-2-methyl propane sulfonic acid monomers, N-vinyl-2-pyrrolidone monomers, 4-vinylpyridine monomers, 1-vinylimidazole monomers, sodium 4-vinylbenzenesulfonate monomers, or combinations thereof.

31. The method of claim 14, wherein said polymer comprises:
(I) recurring units of 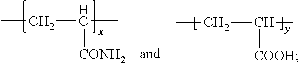
(II) recurring units of 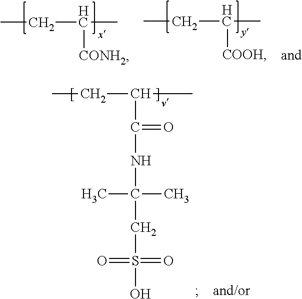
(III) recurring units of

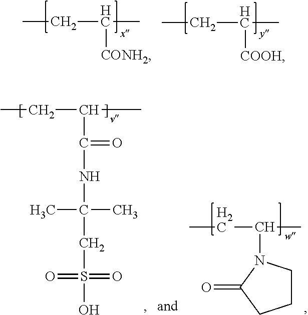

32. The method of claim 14, wherein said amino acid compound is chosen from lysine, polylysine, lysine-monohydrochloride, polyarginine, polyhistidine, or combinations thereof.

33-35. (canceled)
